(19) United States
(12) Patent Application Publication
(10) Pub. No.: US 2025/0191834 A1
(43) Pub. Date: Jun. 12, 2025

(54) COIL COMPONENT

(71) Applicant: Murata Manufacturing Co., Ltd., Kyoto-fu (JP)

(72) Inventors: Kodai IWASA, Nagaokakyo-shi (JP); Masashi MIYAMOTO, Nagaokakyo-shi (JP); Tarou TSUJIBAYASHI, Nagaokakyo-shi (JP); Ryo NARAHARA, Nagaokakyo-shi (JP); Shogo TOKOI, Nagaokakyo-shi (JP)

(73) Assignee: Murata Manufacturing Co., Ltd., Kyoto-fu (JP)

(21) Appl. No.: 19/058,365

(22) Filed: Feb. 20, 2025

Related U.S. Application Data
(63) Continuation of application No. PCT/JP2023/026908, filed on Jul. 22, 2023.

(30) Foreign Application Priority Data
Aug. 23, 2022 (JP) 2022-132156

(51) Int. Cl. H01F 27/29; H01F 27/28; H01F 27/30

(52) U.S. Cl. CPC H01F 27/292; H01F 27/2823; H01F 27/306

(57) ABSTRACT

A coil component includes a core, and flange portions of a core include mounting surfaces, top surfaces, inner end faces, outer end faces, first side surfaces, and second side surfaces, respectively. The metal terminals include mounting surface facing portions ‘that face mounting surfaces, outer end face facing portions that face the outer end faces, and side surface facing portions that face at least one of the first side surfaces and the second side surfaces. The mounting surface facing portions include mounting connected portions and wire connected portions, and the mounting connected portions and the wire connected portions are isolated from each other. The mounting connected portions are connected from one of the outer end face facing portions and the side surface facing portions, and the wire connected portions are connected from the other of the outer end face facing portions and the side surface facing portions.

### CROSS-REFERENCE TO RELATED APPLICATIONS

This application claims benefit of priority to International Patent Application No. PCT/JP2023/026908, filed Jul. 22, 2023, and to Japanese Patent Application No. 2022-132156, filed Aug. 23, 2022, the entire contents of each are incorporated herein by reference.

### BACKGROUND

### Technical Field

This disclosure relates to a wire-wound coil component having a structure in which a wire is wound around a core, and more particularly, to a structure of a metal terminal made from a metal plate attached to the core.

### Background Art

For example, Japanese Unexamined Patent Application Publication No. 2017-199841 describes a wire-wound coil component having a structure in which a wire is wound around a core. More specifically, the core includes a winding core portion that extends in an axial direction and a pair of flange portions provided at end portions of the winding core portion opposite to each other in the axial direction. A metal terminal made from a metal plate is attached to each of the flange portions and is fixed with an adhesive. The wire is wound around the winding core portion and connected to the metal terminals.

Each of the flange portions includes a mounting surface that faces a mounting board when mounted, a top surface that faces away from the mounting surface, an inner end face that couples the mounting surface and the top surface to each other and faces the winding core portion and on which the end portion of the winding core portion in the axial direction is disposed, and an outer end face that faces away from the inner end face.

On the other hand, each of the metal terminals includes a mounting surface facing portion that faces the mounting surface of the flange portion and an outer end face facing portions that faces the outer end face of the flange portion. The mounting surface facing portion includes a mounting connected portion that is connected to a conductor closer to the mounting board when mounted and a wire connected portion to which the wire is connected, and the mounting connected portion and the wire connected portion are isolated from each other.

Japanese Unexamined Patent Application Publication No. 2017-199841 describes that laser welding is used to connect the wire to the wire connected portion. When the mounting connected portion and the wire connected portion are isolated from each other as described above, it is expected that heat during welding of the wire is less likely to be transferred to the mounting connected portion.

### SUMMARY

In the coil component described in Japanese Unexamined Patent Application Publication No. 2017-199841, the mounting connected portion and the wire connected portion that constitute the mounting surface facing portion of the metal terminal are both connected from the outer end face facing portion through a folded portion.

When an attempt is made to connect the wire to the wire connected portion by thermal pressure bonding, the external force applied to the wire connected portion during thermal pressure bonding is applied to the outer end face facing portion connected to the wire connected portion. In addition, even when the coil component is mounted on the mounting board, the external force applied to the mounting connected portion is applied to the outer end face facing portion connected to the mounting connected portion. Concentration of the external force on the outer end face facing portion may cause a terminal electrode to be detached from the flange portion.

Accordingly, the present disclosure provides a coil component having a structure in which an external force is less likely to concentrate on a specific portion of the coil component in a process of connecting the wire to the metal terminal and a process of mounting the coil component on the mounting board.

The present disclosure is applied to a coil component including a core including a winding core portion that extends in an axial direction and a first flange portion and a second flange portion that are provided at end portions of the winding core portion that are opposite to each other in the axial direction; a metal terminal, made from a metal plate, that is attached to the first flange portion; and at least one wire connected to the metal terminal and wounded around the winding core portion.

The first flange portion includes a mounting surface that faces a mounting board when mounted, a top surface that faces away from the mounting surface, an inner end face that couples the mounting surface and the top surface to each other and faces the winding core portion and on which the end portion of the winding core portion in the axial direction is disposed, an outer end face that faces away from the inner end face, and a first side surface and a second side surface, facing away from each other, that couple the inner end face and the outer end face to each other.

The present disclosure is characterized by having the following structure.

The metal terminal includes a mounting surface facing portion that faces the mounting surface, an outer end face facing portion that faces the outer end face, and a side surface facing portion that faces at least one of the first side surface and the second side surface.

The mounting surface facing portion includes a mounting connected portion connectable to a conductor closer to the mounting board when mounted and a wire connected portion to which the wire is connectable.

The mounting connected portion and the wire connected portion are isolated from each other.

The mounting connected portion is connected from one of the outer end face facing portion and the side surface facing portion through a folded portion, and the wire connected portion is connected from the other of the outer end face facing portion and the side surface facing portion through a folded portion.

According to the present disclosure, the mounting connected portion and the wire connected portion are isolated from each other, the mounting connected portion is connected to one of the outer end face facing portion and the side surface facing portion, and the wire connected portion is connected to the other of the outer end face facing portion and the side surface facing portion. Accordingly, the load on the mounting connected portion can be applied to one of the outer end face facing portion and the side surface facing portion, and the load on the wire connected portion can be applied to the other of the outer end face facing portion and the side surface facing portion, and accordingly, these loads can be advantageously distributed. Accordingly, the wire connected portion is less affected by loads, such as heat and stress, applied to the mounting connected portion, and the mounting connected portion is less affected by loads, such as heat and stress, applied to the wire connected portion.

In addition, since the metal terminal includes the side surface facing portion that faces at least one of the first side surface and the second side surface in addition to the mounting surface facing portion that faces the mounting surface and the outer end face facing portion that faces the outer end face, face-to-face facing is achieved in at least three positions are between the metal terminal and the first flange portion.

This enables loads, such as heat and stress, applied to the metal terminals to be advantageously distributed, thereby making the metal terminals less likely to be detached from the first flange portion.

### BRIEF DESCRIPTION OF THE DRAWINGS

FIG. 1 is a perspective view illustrating an appearance of a coil component according to a first embodiment of the present disclosure with mounting surfaces facing upward;

FIG. 2 is a perspective view illustrating a mounting state of the coil component illustrated in FIG. 1;

FIG. 3 is a perspective view for describing a typical external force applied to the coil component in the mounting state illustrated in FIG. 2;

FIG. 4 is a perspective view illustrating an appearance of a coil component according to a second embodiment of the present disclosure with the mounting surfaces facing upward;

FIG. 5 is a perspective view illustrating an appearance of a coil component according to a third embodiment of the present disclosure with the mounting surfaces facing upward;

FIG. 6 is a cross-sectional view taken along line VI-VI in FIG. 5.

### DETAILED DESCRIPTION

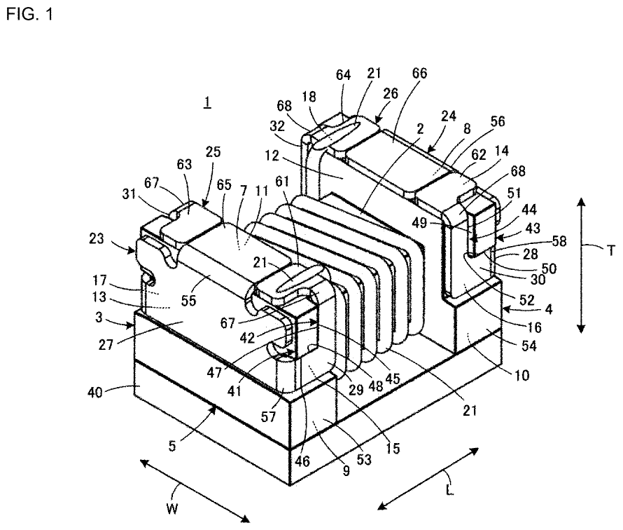

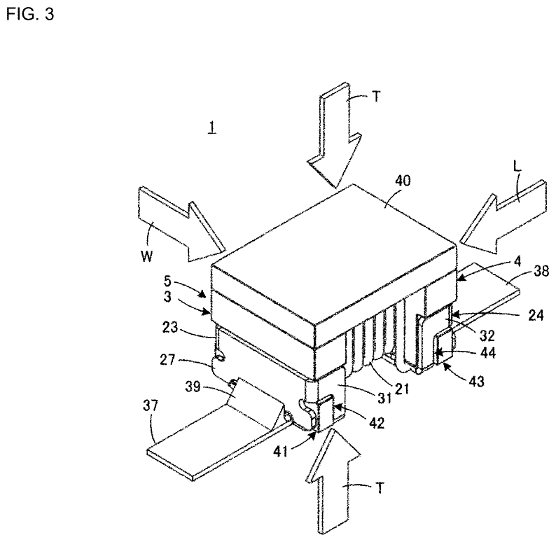

A coil component 1 according to a first embodiment of the present disclosure will be described with reference to FIGS. 1 to 3.

The coil component 1 includes a drum-shaped core 5 that includes a winding core portion 2 that extends in an axial direction (L direction) and a pair of flange portions, that is, a first flange portion 3 and a second flange portion 4, provided at end portions of the winding core portion 2 opposite to each other in the L direction. The core 5 is made of a magnetic material such as ferrite, a resin containing ferrite powder or metal magnetic powder, or a non-magnetic material such as alumina. The winding core portion 2 has a substantially square cross-sectional shape in the drawing but may also have a polygonal shape such as a hexagonal shape, a circular shape, an elliptical shape, or a shape obtained by these shapes being combined.

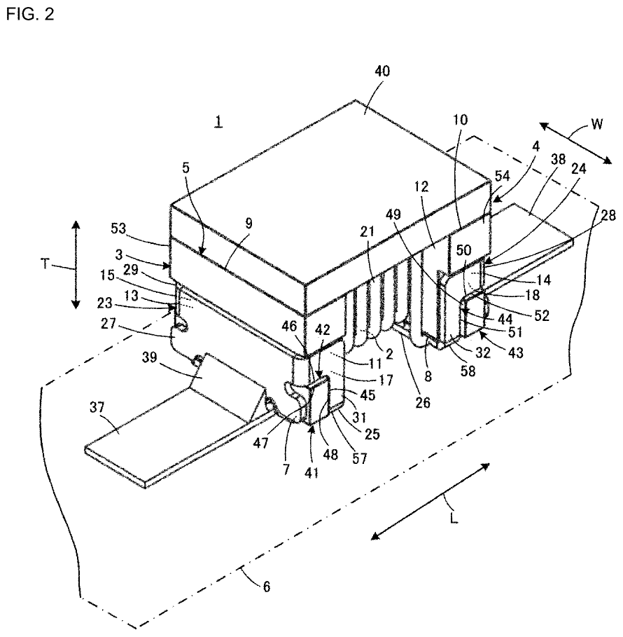

The first flange portion 3 includes a mounting surface 7 that faces a mounting board 6 (see FIG. 2) when mounted, a top surface 9 that faces away from the mounting surface 7, an inner end face 11 that couples the mounting surface 7 and the top surface 9 to each other and faces the winding core portion 2 and on which the end portion of the winding core portion 2 in the L direction is disposed, an outer end face 13 that faces away from the inner end face 11, and a first side surface 15 and a second side surface 17, facing away from each other, that couple the inner end face 11 and the outer end face 13 to each other.

Similarly, the second flange portion 4 includes a mounting surface 8 that faces the mounting board 6 when mounted, a top surface 10 that faces away from the mounting surface 8, an inner end face 12 that couples the mounting surface 8 and the top surface 10 to each other and faces the winding core portion 2 and on which the end portion of the winding core portion 2 in the L direction is disposed, an outer end face 14 that faces away from the inner end face 12, and a first side surface 16 and a second side surface 18, facing away from each other, that couple the inner end face 12 and the outer end face 14 to each other.

The dimensions of the core 5 are not limited but, for example, the dimension in the L direction is 3.2 mm, the dimension in a direction (W direction), orthogonal to the L direction, in which the mounting surfaces 7 and 8 and the top surfaces 9 and 10 extend is 2.5 mm, and the dimension in a direction (T direction) in which the mounting surfaces 7 and 8 and the top surfaces 9 and 10 are connected to each other is 1.8 mm.

The coil component 1 constitutes, for example, a wound-type inductor and includes a wire 21 wound around the winding core portion 2 of the core 5. The wire 21 includes a central wire rod made of a good conductive metal such as, for example, copper, silver, or gold, and an insulating coating, made of an electrically insulating resin such as polyamide-imide, polyurethane, or polyester-imide, that covers the central conductor. The diameter of the center wire of the wire 21 is not specified but preferably 80 μm or more and 200 μm or less (i.e., from 80 μm to 200 μm), for example. In addition, the number of turns of the wire 21 on the winding core portion 2 is not limited.

A pair of metal terminals 23 and 24 is attached to the flange portions 3 and 4, respectively. More specifically, the first metal terminal 23 is attached to the first flange portion 3, and the second metal terminal 24 is attached to the second flange portion 4. A first end portion and a second end portion of the wire 21 that are opposite to each other are connected to the first metal terminal 23 and the second metal terminal 24, respectively.

Each of the first metal terminal 23 and the second metal terminal 24 is made from a single metal plate and have substantially the same shape or a point-symmetric shape. The metal plate constituting each of the metal terminals 23 and 24 is a plate on which, for example, Ni plating and Sn plating are applied onto a base material made of phosphor bronze.

The first metal terminal 23 includes a mounting surface facing portion 25, an outer end face facing portion 27, a first side surface facing portion 29, and a second side surface facing portion 31 that face the mounting surface 7, the outer end face 13, the first side surface 15, and the second side surface 17 of the first flange portion 3, respectively. The second metal terminal 24 includes a mounting surface facing portion 26, an outer end face facing portion 28, a first side surface facing portion 30, and a second side surface facing portion 32 that face the mounting surface 8, the outer end face 14, the first side surface 16, and the second side surface 18 of the second flange portion 4, respectively.

In the first metal terminal 23, the mounting surface facing portion 25 is divided into a first mounting surface facing end portion 61 closer to the first side surface 15, a second mounting surface facing end portion 63 closer to the second side surface 17, and a mounting surface facing central portion 65 sandwiched between the first mounting surface facing end portion 61 and the second mounting surface facing end portion 63. In addition, the mounting surface facing central portion 65 is connected to the outer end face facing portion 27 through a first folded portion 55, and the first mounting surface facing end portion 61 and the second mounting surface facing end portion 63 are connected to the first side surface facing portion 29 and the second side surface facing portion 31, respectively, through a third folded portion 67.

Similarly, in the second metal terminal 24, the mounting surface facing portion 26 is divided into a first mounting surface facing end portion 62 closer to the first side surface 16, a second mounting surface facing end portion 64 closer to the second side surface 18, and a mounting surface facing central portion 66 sandwiched between the first mounting surface facing end portion 62 and the second mounting surface facing end portion 64. In addition, the mounting surface facing central portion 66 is connected to the outer end face facing portion 28 through a first folded portion 56, and the first mounting surface facing end portion 62 and the second mounting surface facing end portion 64 are connected to the first side surface facing portion 30 and the second side surface facing portion 32, respectively, through a third folded portion 68.

As illustrated in FIG. 2, the coil component 1 is mounted with the metal terminals 23 and 24 connected to conductive lands 37 and 38 provided on the mounting board 6 via solder. At this time, solder is applied to the mounting surface facing central portions 65 and 66 of the metal terminals 23 and 24. In the mounting state illustrated in FIG. 2, the mounting surface facing central portions 65 and 66 serve as “the mounting connected portions” connectable to the conductive lands 37 and 38 closer to the mounting board 6. FIG. 2 illustrates a fillet 39 made of solder that connects the conductive land 37 and the first metal terminal 23 to each other.

In addition, in the first metal terminal 23, the first end portion of the wire 21 is connected to one of the first mounting surface facing end portion 61 and the second mounting surface facing end portion 63, for example, the first mounting surface facing end portion 61. In the second metal terminal 24, the second end portion of the wire 21 is connected to one of the first mounting surface facing end portion 62 and the second mounting surface facing end portion 64, for example, the second mounting surface facing end portion 64. Accordingly, the first mounting surface facing end portion 61 and the second mounting surface facing end portion 63 and the first mounting surface facing end portion 62 and the second mounting surface facing end portion 64 serve as “the wire connected portions” to which the wire 21 is connectable. It should be noted that the wire is connected to not all of the first mounting surface facing end portion 61, the second mounting surface facing end portion 63, the first mounting surface facing end portion 62, and the second mounting surface facing end portion 64, which serve as “the wire connected portions”. Accordingly, the wire connected portion refers to a portion to which the wire is connectable.

For example, thermal pressure bonding is used for connection between the wire 21 and the metal terminals 23 and 24 described above. As illustrated in the drawing, after the first end portion of the wire 21 is connected to the first mounting surface facing end portion 61 of the first metal terminal 23 and the second end portion of the wire 21 is connected to the second mounting surface facing end portion 64 of the second metal terminal 24, the excess portions at the ends of the wire 21 are cut and removed. Since the excess portions are cut, the edges of the first mounting surface facing end portion 61 and the second mounting surface facing end portion 64 closer to the outer end faces 13 and 14 can be advantageously used.

A top plate 40 is provided for the coil component 1 so as to couple the top surface 9 of the first flange portion 3 and the top surface 10 of the second flange portion 4 of the core 5 to each other. The top plate 40 is joined to the core 5 with an adhesive. For example, an epoxy resin with a thermosetting property is used as the adhesive. An inorganic filler, such as a silica filler, may be added to the adhesive to improve thermal shock resistance. A printing method that applies the adhesive to the top plate 40, a method that dips the top surfaces 9 and 10 of the flange portions 3 and 4 of the core 5 into the adhesive, or a method that dispenses and applies the adhesive to both the top plate 40 and the core 5 can be used to apply the adhesive.

A magnetic material such as ferrite, a resin containing ferrite powder or metal magnetic powder, or a non-magnetic material such as alumina can be used as the material of the top plate 40. When both the core 5 and the top plate 40 are made of a magnetic material, the core 5 and the top plate 40 form a closed magnetic circuit. A resin coating may be applied instead of the top plate 40. It should be noted that the top plate 40 or the resin coating are not necessary.

In the structure described above, the following operation and effect are obtained.

Referring to FIGS. 1 to 3, in the mounting state of the coil component 1, it is possible to withstand external forces in two positive and negative direction of the L direction of the external forces acting on the core 5 by contact between the outer end face 13 of the first flange portion 3 and the outer end face facing portion 27 of the first metal terminal 23 and contact between the outer end face 14 of the second flange portion 4 and the outer end face facing portion 28 of the second metal terminal 24.

In addition, in the mounting state of the coil component 1, it is possible to withstand external forces in two positive and negative directions of the W direction of the external forces acting on the core 5 by contact between the first side surface 15 of the first flange portion 3 and the first side surface facing portion 29 of the first metal terminal 23, contact between the second side surface 17 of the first flange portion 3 and the second side surface facing portion 31 of the first metal terminal 23, contact between the first side surface 16 of the second flange portion 4 and the first side surface facing portion 30 of the second metal terminal 24, and contact between the second side surface 18 of the second flange portion 4 and the second side surface facing portion 32 of the second metal terminal 24.

In addition, in the mounting state of the coil component 1, it is possible to withstand an external force in a direction from the top surfaces 9 and 10 to the mounting surfaces 7 and 8 of the T direction of the external forces acting on the core 5 by contact between the mounting surface 7 of the first flange portion 3 and the mounting surface facing portion 25 of the first metal terminal 23 and contact between the mounting surface 8 of the second flange portion 4 and the mounting surface facing portion 26 of the second metal terminal 24.

As described above, it is possible to withstand at least the external forces in the five directions described above to prevent the metal terminals 23 and 24 from being detached from the flange portions 3 and 4.

The present embodiment has a structure that makes the metal terminals 23 and 24 less likely to be detached from the flange portions 3 and 4. That is, the present embodiment further includes a regulating portion that prevents the metal terminals 23 and 24 from moving with respect to the flange portions 3 and 4 in a direction in which at least the mounting surface facing portions 25 and 26 are away from the mounting surfaces 7 and 8 and a direction in which at least the outer end face facing portions 27 and 28 are away from the outer end faces 13 and 14.

An external force from the mounting surfaces 7 and 8 to the top surfaces 9 and 10 in the T direction of the external forces acting on the core 5 is not normally caused when the coil component 1 is mounted on the mounting board but may be caused instantaneously due to a drop impact or the like. The regulating portion described above is effective against an external force from the mounting surfaces 7 and 8 to the top surfaces 9 and 10 in the T direction of the external forces acting on the core 5.

More specifically, in the case of the first metal terminal 23, the regulating portion is formed by a first raised portion 41 provided on at least one of the first side surface 15 and the second side surface 17 of the first flange portion 3 and a cutout portion 42, located in at least one of the first side surface facing portion 29 and the second side surface facing portion 31 of the first metal terminal 23, that receives the first raised portion 41.

In addition, in the case of the second metal terminal 24, the regulating portion is formed by a first raised portion 43 provided on at least one of the first side surface 16 and the second side surface 18 of the second flange portion 4 and a cutout portion 44, located in at least one of the first side surface facing portion 30 and the second side surface facing portion 32 of the second metal terminal 24, that receives the first raised portion 43.

As described above, when at least one of the first side surface facing portion 29 and the second side surface facing portion 31 of the first metal terminal 23 is selected as a position at which the cutout portion 42 is provided, it is possible to increase the areas of the outer end face facing portion 27 and the mounting surface facing portion 25 of the first metal terminal 23, which receive relatively large external forces. The same applies to the cutout portion 44 of the second metal terminal 24. Accordingly, the effect of making the metal terminals 23 and 24 less likely to be detached from the flange portions 3 and 4 can be further improved.

In the present embodiment, in the case of the first metal terminal 23, the first raised portion 41 is provided on each of the first side surface 15 and the second side surface 17 of the first flange portion 3, and the cutout portion 42 is located on each of the first side surface facing portion 29 and the second side surface facing portion 31 of the first metal terminal 23. In addition, in the case of the second metal terminal 24, the first raised portion 43 is provided on each of the first side surface 16 and the second side surface 18 of the second flange portion 4, and the cutout portion 44 is located on each of the first side surface facing portion 30 and the second side surface facing portion 32 of the second metal terminal 24.

When the first raised portions 41 are provided on each of the first side surface 15 and the second side surface 17 of the first flange portion 3, and the first raised portions 43 are provided on each of the first side surface 16 and the second side surface 18 of the second flange portion 4 as described above, the effect of making the metal terminals 23 and 24 less likely to be detached from the flange portions 3 and 4 can be improved.

The regulating portion formed by combination of the first raised portions 41 and 43 and the cutout portions 42 and 44 as described above can prevent movement not only in a direction in which the mounting surface facing portions 25 and 26 are away from the mounting surfaces 7 and 8 but also in a direction in which the outer end face facing portions 27 and 28 are away from the outer end faces 13 and 14.

In the present embodiment, in the case of the first metal terminal 23, the first raised portion 41 gives a first rising wall 45 that extends in a direction in which the top surface 9 of the first flange portion 3 faces the mounting surface 7 and a second rising wall 46 that extends in a direction in which the outer end face 13 faces the inner end face 11, and the cutout portion 42 gives a first facing wall 47 that faces the first rising wall 45 and a second facing wall 48 that faces the second rising wall 46.

In addition, in the case of the second metal terminal 24, the first raised portion 43 gives a first rising wall 49 that extends in a direction in which the top surface 10 of the second flange portion 4 faces the mounting surface 8 and a second rising wall 50 that extends in a direction in which the outer end face 14 faces the inner end face 12, and the cutout portion 44 gives a first facing wall 51 that faces the first rising wall 49 and a second facing wall 52 that faces the second rising wall 50.

As viewed in a direction that faces the first side surfaces 15 and 16 and the second side surfaces 17 and 18, the first rising walls 45 and 49 preferably extend linearly in parallel to the inner end faces 11 and 12, respectively, and the second rising walls 46 and 50 preferably extend linearly in parallel to the mounting surfaces 7 and 8, respectively.

When the first rising walls 45 and 49 extend linearly in parallel to the inner end faces 11 and 12, and the second rising walls 46 and 50 extend linearly in parallel to the mounting surfaces 7 and 8 as described above, it is possible to surely suppress the metal terminals 23 and 24 from being detached from the flange portions 3 and 4 in the direction in which the mounting surface facing portions 25 and 26 are away from the mounting surfaces 7 and 8 and in the direction in which the outer end face facing portions 27 and 28 are away from the outer end faces 13 and 14 without any bias of forces.

In addition, as viewed in a direction that faces the first side surface 15 and the second side surface 17 of the first flange portion 3, the first raised portion 41 is located in contact with a corner at which the outer end face 13 and the mounting surface 7 intersect each other on the first side surface 15 and the second side surface 17, and the cutout portion 42 is located at a predetermined distance from the edges of the first side surface facing portion 29 and the second side surface facing portion 31 of the first metal terminal 23 closer to the inner end face 11 and the edges thereof closer to the top surface 9. In other words, the first side surface facing portion 29 and the second side surface facing portion 31 form an L-shape that is biased toward the inner end face 11 and the top surface 9.

Similarly, as viewed in a direction that faces the first side surface 16 and the second side surface 18 of the second flange portion 4, the first raised portion 43 is located in contact with a corner at which the outer end face 14 and the mounting surface 8 intersect each other on the first side surface 16 and the second side surface 18, and the cutout portion 44 is located at a predetermined distance from the edges of the first side surface facing portion 30 and the second side surface facing portion 32 of the second metal terminal 24 closer to the inner end face 12 and the edges thereof closer to the top surface 10. In other words, the first side surface facing portion 30 and the second side surface facing portion 32 form an L-shape that is biased toward the inner end face 12 and the top surface 10.

In the arrangement of the first raised portions 41 and 43 and the cutout portions 42 and 44 as described above, the areas of the first raised portions 41 and 43 can be increased. In addition, since the rising walls of the first raised portions 41 and 43 along the mounting surfaces 7 and 8 are flush with the mounting surfaces 7 and 8, and the rising walls of the first raised portions 41 and 43 along the outer end faces 13 and 14 are flush with the outer end faces 13 and 14, the core 5 including the first raised portions 41 and 43 are easily formed.

In addition, preferably, the first flange portion 3 further includes a second raised portion 53 that faces at least a portion of an edge of the first metal terminal 23 closer to the top surface 9 in the direction in which the top surface 9 faces the mounting surface 7, and the second flange portion 4 further includes a second raised portion 54 that faces at least a portion of an edge of the second metal terminal 24 closer to the top surface 10 in the direction in which the top surface 10 faces the mounting surface 8.

In the second raised portions 53 and 54 as described above, it is possible to more surely suppress the metal terminals 23 and 24 from being detached from the flange portions 3 and 4 by an external force in the rotation direction about the axial line that faces the W direction and an external force in the rotation direction about the axial line that faces the L direction. It should be noted that the external force in the rotation direction about the axial line that faces the W direction may be caused when, for example, a temperature change occurs with the coil component 1 mounted on the mounting board 6, and a difference in thermal expansion between the core 5 and the mounting board 6 causes the mounting board 6 to expand more than the core 5.

In the present embodiment, the second raised portion 53 is provided over the first side surface 15, the outer end face 13, and the second side surface 17 of the first flange portion 3, and the second raised portion 54 is provided over the first side surface 16, the outer end face 14, and the second side surface 18 of the second flange portion 4.

In terms of the resistance to the external force in the rotation direction described above, it is particularly effective that the second raised portion 53 is provided so as to face the edges of the first side surface facing portion 29 and the second side surface facing portion 31 of the first metal terminal 23 closer to the top surface 9, and the second raised portion 54 is provided so as to face the edges of the first side surface facing portion 30 and the second side surface facing portion 32 of the second metal terminal 24 closer to the top surface 10.

It should be noted that the outer end face facing portions 27 and 28 of the metal terminals 23 and 24 can form steps on the outer end faces 13 and 14 of the flange portions 3 and 4, but the portions of the second raised portions 53 and 54 located on the outer end faces 13 and 14 contribute to elimination or reduction of the steps described above. Accordingly, it is possible to make inconvenience, such as insertion of the tips of tweezers into a portion between the outer end face facing portions 27 and 28 of the metal terminals 23 and 24 and the outer end faces 13 and 14 of the flange portions 3 and 4 less likely to occur.

In the coil component 1 described above, the mounting surface facing central portions 65 and 66, which serve as “the mounting connected portions”, and the mounting surface facing end portions 61 to 64, which serve as “the wire connected portions”, are isolated from each other. Furthermore, the mounting surface facing end portions 61 to 64 are connected to the outer end face facing portions 27 and 28 through the side surface facing portions 29 to 32.

Accordingly, the mounting surface facing end portions 61 to 64 are less affected by loads, such as heat and stress, applied to the mounting surface facing central portions 65 and 66, and the mounting surface facing central portions 65 and 66 are less affected by loads, such as heat and stress, applied to the mounting surface facing end portions 61 to 64. Therefore, the connection reliability between the mounting board 6 and the metal terminals 23 and 24 and the connection reliability between the metal terminals 23 and 24 and the wire 21 can be improved.

It should be noted that the stress applied to the mounting surface facing end portions 61 to 64 is, for example, stress applied when the wire 21 is connected to a specific one of the mounting surface facing end portions 61 to 64 by thermal pressure bonding. If the mounting surface facing end portions 61 to 64, which serve as “the wire connected portions”, are directly connected from the outer end face facing portions 27 and 28 through the folded portions, the mounting surface facing end portions 61 to 64 may move so as to be inclined in the T direction due to the stress described above with ridge line in which the outer end faces 13 and 14 of the flange portions 3 and 4 intersect the mounting surfaces 7 and 8 as the fulcrum. In particular, the movement of the mounting surface facing end portions 61 to 64 is larger on the sides closer to the inner end faces 11 and 12 that are relatively far from the fulcrum described above.

Here, since the wire 21 extends from the inner end faces 11 and 12, poor connection of the wire 21 may occur or the wire 21 may be broken in the edge portions of the mounting surface facing end portions 61 to 64. In particular, when the direction in which the wire 21 is drawn is orthogonal to the direction in which the edge portions of the mounting surface facing end portions 61 to 64 extend, the wire 21 is more likely to be broken.

On the other hand, when the mounting surface facing end portions 61 to 64, which serve as “the wire connected portions”, extend from the side surface facing portions 29 to 32, the ridge line in which the side surfaces 15 to 18 intersect the mounting surfaces 7 and 8 is the fulcrum. Accordingly, since the distance from this fulcrum to the inner end faces 11 and 12 of the mounting surface facing end portions 61 to 64 is relatively short, the amount of deflection of the mounting surface facing end portions 61 to 64 during thermal pressure bonding can be reduced, and poor connection of the wire 21 is less likely to occur.

In addition, when the mounting surface facing end portions 61 to 64, which serve as “the wire connected portions”, extend from the side surface facing portions 29 to 32, it is possible to make the metal terminals 23 and 24 less likely to be detached from the flange portions 3 and 4.

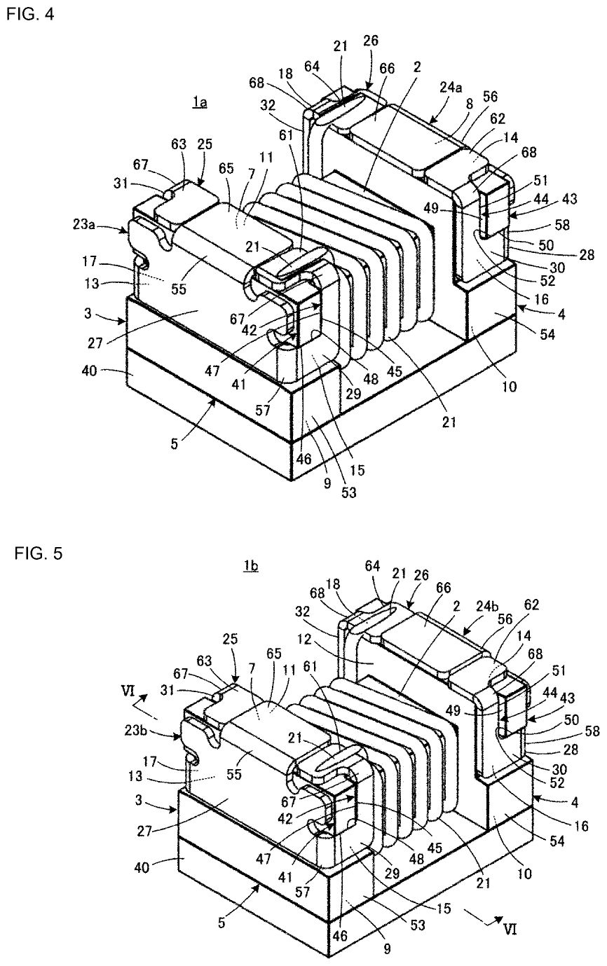

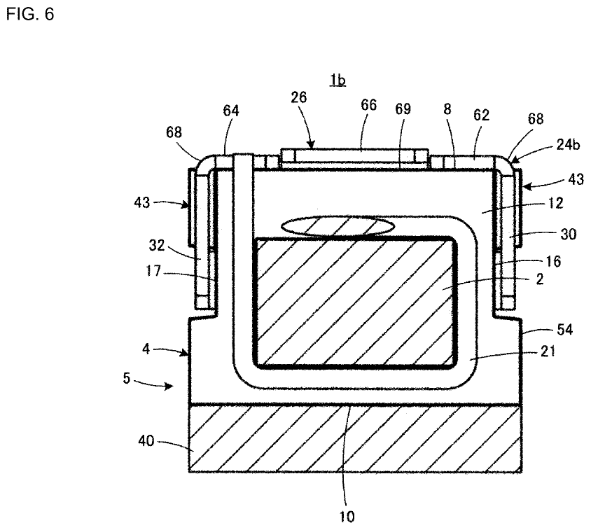

FIGS. 4 and 5 illustrate a coil component 1a according to a second embodiment of the present disclosure and a coil component 1b according to a third embodiment and correspond to FIG. 1. FIG. 6 is a cross-sectional view taken along line VI-VI in FIG. 5. In FIGS. 4 to 6, components corresponding to those illustrated in FIG. 1 are denoted by the same reference numerals to omit duplicate descriptions.

The coil component 1a illustrated in FIG. 4 differs from the coil component 1 illustrated in FIG. 1 in the forms of the mounting surface facing end portions 61 to 64 of metal terminals 23a and 24a. More specifically, of the mounting surface facing end portions 61 to 64, which serve as “the wire connected portions”, the mounting surface facing end portions 61 and 64 that have actually served as “the wire connected portions” have a gradient of the height from the mounting surfaces 7 and 8 of the flange portions 3 and 4 that becomes lower toward the inner end faces 11 and 12 from the outer end faces 13 and 14.

In the structure as described above, when the wire 21 is connected to a specific one of the mounting surface facing end portions 61 to 64, it is possible to draw the wire 21 while guiding it smoothly and to eliminate a concern that the wire 21 is undesirably cut at the edges of the mounting surface facing end portions 61 to 64 closer to the inner end face 11 and 12 after the wire 21 is connected.

It should be noted that all of the mounting surface facing end portions 61 to 64, which serve as “the wire connected portions”, may have a gradient that becomes lower from the outer end faces 13 and 14 toward the inner end faces 11 and 12. Since the wire 21 can remain thick after pressure bonding of the wire 21 in this structure, the wire 21 is less likely to be broken.

In the coil component 1b illustrated in FIGS. 5 and 6, the height of metal terminals 23b and 24b from the mounting surfaces 7 and 8 of the flange portions 3 and 4 in the mounting surface facing central portions 65 and 66, which serve as “the mounting connected portions”, is larger than that of the mounting surface facing end portions 61 to 64, which serve as “the wire connected portions”. FIG. 6 clearly illustrates the positional relationship between the mounting surface facing central portion 66 and the mounting surface facing end portions 62 and 64 with respect to the mounting surface 8 of the second flange portion 4.

The end portion of the wire 21 connected to a specific one of the mounting surface facing end portions 61 to 64 is crushed by thermal pressure bonding, but the thickness of the connected end portion of the wire 21 described above can be absorbed by the height difference described above. A gap 69 (see FIG. 6) between the mounting surface facing central portions 65 and 66 and the mounting surfaces 7 and 8 of the flange portions 3 and 4 caused by the height difference is preferably, for example, 200 μm or less, and the gap between the mounting surface facing end portions 61 to 64 and the mounting surfaces 7 and 8 of the flange portions 3 and 4 is smaller than the gap 69.

The present disclosure has been described by using the illustrated embodiment, but various other embodiments are possible within the scope of the present disclosure.

For example, the coil component to which the present disclosure is applied is not limited to a single coil as in the illustrated embodiment and may be a common mode choke coil, a transformer, a balun, or the like. Accordingly, the number of wires may also be changed depending on the function of the coil component, and accordingly, the number of metal terminals provided for each of the flange portions may also be changed. Typically, two metal terminals may be disposed side by side in the W direction for one flange portion.

When two metal terminals are disposed side by side in the W direction for one flange portion as described above, each of the metal terminals includes a mounting surface facing portion that faces a region with a dimension less than half the dimension of the mounting surface in the width direction, an outer end face facing portion that faces a region with a dimension less than half the dimension of the outer end face in the width direction, and a side surface facing portion that faces one of the first side surface and the second side surface. In addition, the mounting surface facing portion described above includes the mounting connected portion connectable to the conductor closer to the mounting board when mounted and the wire connected portion to which the wire is connectable, but the dimension in the width direction of the mounting surface facing central portion, which serves as the mounting connected portion, is less than half the illustrated width dimension, and accordingly, the mounting surface facing portion includes one mounting surface facing end portion as the wire connected portion.

In addition, in the present disclosure, an adhesive need not necessarily be used to attach and fix the metal terminals 23 and 24 to the flange portions 3 and 4. However, the present disclosure does not exclude use of an adhesive.

In addition, the mounting surface facing central portion 65 is located between the first mounting surface facing end portion 61 and the second mounting surface facing end portion 63, and the mounting surface facing central portion 66 is located between the first mounting surface facing end portion 62 and the second mounting surface facing end portion 64, but the wire 21 may be connected to the mounting surface facing central portions 65 and 66, and the first mounting surface facing end portion 61 and 62 or the second mounting surface facing end portion 63 and 64 may be connected to the conductive lands on the mounting board.

In addition, the first metal terminal 23 and the second metal terminal 24 have the same structure in the illustrated embodiment, but only one of the first metal terminal 23 and the second metal terminal 24, for example, only the first metal terminal 23 may have the characteristic structure of the present disclosure. In this case, the second metal terminal 24 may be made from a metal plate that does not have the characteristic structure of the present disclosure or may be made from a conductor film obtained by, for example, baking a conductive paste.

In addition, when the coil component according to the present disclosure is configured, partial substitution or combination of the structure is possible among different embodiments described in this specification.

Aspects of the present disclosure will be described below.

<1> A coil component comprising a core including a winding core portion that extends in an axial direction and a first flange portion and a second flange portion that are provided at end portions of the winding core portion, the end portions being opposite to each other in the axial direction; a metal terminal, made from a metal plate, that is attached to the first flange portion; and at least one wire connected to the metal terminal and wounded around the winding core portion. The first flange portion includes a mounting surface that faces a mounting board when mounted, a top surface that faces away from the mounting surface, an inner end face that couples the mounting surface and the top surface to each other and faces the winding core portion and on which one of the end portions of the winding core portion in the axial direction is disposed, an outer end face that faces away from the inner end face, and a first side surface and a second side surface, facing away from each other, that couple the inner end face and the outer end face to each other. The metal terminal includes a mounting surface facing portion that faces the mounting surface, an outer end face facing portion that faces the outer end face, and a side surface facing portion that faces at least one of the first side surface and the second side surface, and the mounting surface facing portion includes a mounting connected portion connectable to a conductor closer to the mounting board when mounted and a wire connected portion to which the wire is connectable. The mounting connected portion and the wire connected portion are isolated from each other, the mounting connected portion is connected from one of the outer end face facing portion and the side surface facing portion through a folded portion, and the wire connected portion is connected from the other of the outer end face facing portion and the side surface facing portion through a folded portion.

<2> The coil component according to <1>, wherein the mounting connected portion is connected from the outer end face facing portion through a folded portion, and the wire connected portion is connected from the side surface facing portion through a folded portion.

<3> The coil component according to <1> or <2>, wherein the side surface facing portion is connected from the outer end face facing portion through a folded portion.

<4> The coil component according to any one of <1> to <3>, wherein the metal terminal includes, as the side surface facing portion, a first side surface facing portion that faces the first side surface and a second side surface facing portion that faces the second side surface. The mounting surface facing portion includes, as the wire connected portion, a first wire connected portion and a second wire connected portion. When the first side surface and the second side surface face in a width direction, the first wire connected portion and the second wire connected portion are disposed in individual end portions of the mounting surface, respectively, in the width direction with the mounting connected portion therebetween. The wire is connected to at least one of the first wire connected portion and the second wire connected portion.

<5> The coil component according to any one of <1> to <4>, wherein a height of the mounting connected portion from the mounting surface of the first flange portion is larger than a height of the wire connected portion from the mounting surface of the first flange portion.

<6> The coil component according to any one of <1> to <5>, wherein a height of the wire connected portion from the mounting surface of the first flange portion has a gradient that reduces toward the inner end face from the outer end face.

<7> The coil component according to any one of <1> to <6>, further comprising a regulating portion that prevents the metal terminal from moving with respect to the first flange portion in a direction in which at least the mounting surface facing portion is away from the mounting surface and a direction in which at least the outer end face facing portion is away from the outer end face. The regulating portion is formed by a first raised portion provided on at least one of the first side surface and the second side surface of the first flange portion and a cutout portion located in at least one of the first side surface facing portion and the second side surface facing portion of the metal terminal, that receives the first raised portion.

<8> The coil component according to <7>, wherein the first flange portion further includes a second raised portion that faces at least a portion of an edge of the metal terminal closer to the top surface in a direction in which the top surface faces the mounting surface.

<9> The coil component according to <8>, wherein the second raised portion faces the edge of the side surface facing portion of the metal terminal closer to the top surface.

<10> The coil component according to any one of <1> to <9>, further comprising a second metal terminal, attached to the second flange portion, that is made from a metal plate. A structure of the second metal terminal is the same as a structure of the metal terminal.

What is claimed is:

1. A coil component comprising:
a core including a winding core portion that extends in an axial direction and a first flange portion and a second flange portion that are at end portions of the winding core portion, the end portions being opposite to each other in the axial direction;
a metal terminal, including a metal plate, that is attached to the first flange portion; and
at least one wire connected to the metal terminal and wounded around the winding core portion,
wherein
the first flange portion includes a mounting surface that faces a mounting board when mounted, a top surface that faces away from the mounting surface, an inner end face that couples the mounting surface and the top surface to each other and faces the winding core portion and on which one of the end portions of the winding core portion in the axial direction is disposed, an outer end face that faces away from the inner end face, and a first side surface and a second side surface, facing away from each other, that couple the inner end face and the outer end face to each other,
the metal terminal includes a mounting surface facing portion that faces the mounting surface, an outer end face facing portion that faces the outer end face, and a side surface facing portion that faces at least one of the first side surface and the second side surface, and the mounting surface facing portion includes a mounting connected portion configured to connect to a conductor closer to the mounting board when mounted and a wire connected portion to which the wire is connectable, and
the mounting connected portion and the wire connected portion are isolated from each other, the mounting connected portion is connected from one of the outer end face facing portion and the side surface facing portion through a folded portion, and the wire connected portion is connected from the other of the outer end face facing portion and the side surface facing portion through a folded portion.

2. The coil component according to claim 1, wherein
the mounting connected portion is connected from the outer end face facing portion through a folded portion, and the wire connected portion is connected from the side surface facing portion through a folded portion.

3. The coil component according to claim 1, wherein
the side surface facing portion is connected from the outer end face facing portion through a folded portion.

4. The coil component according to claim 1, wherein
the metal terminal includes, as the side surface facing portion, a first side surface facing portion that faces the first side surface and a second side surface facing portion that faces the second side surface,
the mounting surface facing portion includes, as the wire connected portion, a first wire connected portion and a second wire connected portion,
when the first side surface and the second side surface face in a width direction, the first wire connected portion and the second wire connected portion are in individual end portions of the mounting surface, respectively, in the width direction with the mounting connected portion therebetween, and
the wire is connected to at least one of the first wire connected portion and the second wire connected portion.

5. The coil component according to claim 1, wherein
a height of the mounting connected portion from the mounting surface of the first flange portion is larger than a height of the wire connected portion from the mounting surface of the first flange portion.

6. The coil component according to claim 1, wherein
a height of the wire connected portion from the mounting surface of the first flange portion has a gradient that reduces toward the inner end face from the outer end face.

7. The coil component according to claim 1, further comprising:
a regulating portion that prevents the metal terminal from moving with respect to the first flange portion in a direction in which at least the mounting surface facing portion is away from the mounting surface and a direction in which at least the outer end face facing portion is away from the outer end face,
wherein
the metal terminal includes, as the side surface facing portion, a first side surface facing portion that faces the first side surface and a second side surface facing portion that faces the second side surface, and
the regulating portion is configured by a first raised portion on at least one of the first side surface and the second side surface of the first flange portion and a cutout portion in at least one of the first side surface facing portion and the second side surface facing portion of the metal terminal, that receives the first raised portion.

8. The coil component according to claim 7, wherein
the first flange portion further includes a second raised portion that faces at least a portion of an edge of the metal terminal closer to the top surface in a direction in which the top surface faces the mounting surface.

9. The coil component according to claim 8, wherein
the second raised portion faces an edge of the side surface facing portion of the metal terminal closer to the top surface.

10. The coil component according to claim 1, further comprising:
a second metal terminal, attached to the second flange portion, that is includes a metal plate,
wherein a structure of the second metal terminal is the same as a structure of the metal terminal.

11. The coil component according to claim 2, wherein
the side surface facing portion is connected from the outer end face facing portion through a folded portion.

12. The coil component according to claim 2, wherein
the metal terminal includes, as the side surface facing portion, a first side surface facing portion that faces the first side surface and a second side surface facing portion that faces the second side surface,
the mounting surface facing portion includes, as the wire connected portion, a first wire connected portion and a second wire connected portion,
when the first side surface and the second side surface face in a width direction, the first wire connected portion and the second wire connected portion are in individual end portions of the mounting surface, respectively, in the width direction with the mounting connected portion therebetween, and
the wire is connected to at least one of the first wire connected portion and the second wire connected portion.

13. The coil component according to claim 3, wherein
the metal terminal includes, as the side surface facing portion, a first side surface facing portion that faces the first side surface and a second side surface facing portion that faces the second side surface,
the mounting surface facing portion includes, as the wire connected portion, a first wire connected portion and a second wire connected portion,
when the first side surface and the second side surface face in a width direction, the first wire connected portion and the second wire connected portion are in individual end portions of the mounting surface, respectively, in the width direction with the mounting connected portion therebetween, and
the wire is connected to at least one of the first wire connected portion and the second wire connected portion.

14. The coil component according to claim 2, wherein
a height of the mounting connected portion from the mounting surface of the first flange portion is larger than a height of the wire connected portion from the mounting surface of the first flange portion.

15. The coil component according to claim 3, wherein
a height of the mounting connected portion from the mounting surface of the first flange portion is larger than a height of the wire connected portion from the mounting surface of the first flange portion.

16. The coil component according to claim 2, wherein
a height of the wire connected portion from the mounting surface of the first flange portion has a gradient that reduces toward the inner end face from the outer end face.

17. The coil component according to claim 3, wherein
a height of the wire connected portion from the mounting surface of the first flange portion has a gradient that reduces toward the inner end face from the outer end face.

18. The coil component according to claim 2, further comprising:
a regulating portion that prevents the metal terminal from moving with respect to the first flange portion in a direction in which at least the mounting surface facing portion is away from the mounting surface and a direction in which at least the outer end face facing portion is away from the outer end face,
wherein
the metal terminal includes, as the side surface facing portion, a first side surface facing portion that faces the first side surface and a second side surface facing portion that faces the second side surface, and
the regulating portion is configured by a first raised portion on at least one of the first side surface and the second side surface of the first flange portion and a cutout portion in at least one of the first side surface facing portion and the second side surface facing portion of the metal terminal, that receives the first raised portion.

19. The coil component according to claim 3, further comprising:
a regulating portion that prevents the metal terminal from moving with respect to the first flange portion in a direction in which at least the mounting surface facing portion is away from the mounting surface and a direction in which at least the outer end face facing portion is away from the outer end face,
wherein
the metal terminal includes, as the side surface facing portion, a first side surface facing portion that faces the first side surface and a second side surface facing portion that faces the second side surface, and
the regulating portion is configured by a first raised portion on at least one of the first side surface and the second side surface of the first flange portion and a cutout portion in at least one of the first side surface facing portion and the second side surface facing portion of the metal terminal, that receives the first raised portion.

20. The coil component according to claim 2, further comprising:
a second metal terminal, attached to the second flange portion, that is includes a metal plate,
wherein a structure of the second metal terminal is the same as a structure of the metal terminal.
